(19) United States
(12) Patent Application Publication
(10) Pub. No.: US 2018/0025567 A1
(43) Pub. Date: Jan. 25, 2018

(54) COIN PROCESSING APPARATUS

(71) Applicant: FUJI ELECTRIC CO., LTD., Kawasaki-shi (JP)

(72) Inventor: Shoichi MORINOBU, Yokkaichi (JP)

(73) Assignee: FUJI ELECTRIC CO., LTD., Kawasaki-shi (JP)

(21) Appl. No.: 15/654,439

(22) Filed: Jul. 19, 2017

(30) Foreign Application Priority Data
Jul. 22, 2016 (JP) 2016-143988

(51) Int. Cl. G07D 3/14; G07G 1/12; G07G 1/06; G07F 5/24; G06Q 20/20

(52) U.S. Cl. CPC G07D 3/14; G07F 5/24; G06Q 20/20; G07G 1/06; G07G 1/12; G07G 1/0018

(57) ABSTRACT

A coin processing apparatus includes: a predetermined number of coin storages; and a money input/output control unit configured to set, when a number of the coin storages used as denomination-fixed coin storages is less than the predetermined number, at least one remaining coin storage as a temporary coin storage, and to execute money input/output control of coins by using the denomination-fixed coin storages and the at least one temporary coin storage.

### CROSS-REFERENCE TO RELATED APPLICATION(S)

The present application claims priority to and incorporates by reference the entire contents of Japanese Patent Application No. 2016-143988 filed in Japan on Jul. 22, 2016.

### BACKGROUND

The present disclosure relates to a coin processing apparatus.

A money processing apparatus such as an automatic change machine is connected to a POS (point of sales) register or the like and used, in which a coin processing apparatus that performs input/output processing of coins and a bill processing apparatus that performs input/output processing of bills are integrally configured.

Japanese Patent Application Laid-open No. 2010-33410 relates to a coin processing apparatus that includes an output port from which coins transferred by output-money transfer means is output, switching means arranged in the middle of a transfer path of coins from a storage unit to the output port to switch a transfer direction of coins to be transferred at the time of collecting coins stored in the storage unit, and a coin collection unit arranged at a transfer destination of coins, whose transfer direction has been switched by the switching means, to collect coins. That is, when coins are collectively collected, the coin collection unit is provided at a lower part of the coin processing apparatus to collect coins safely.

When a coin collection unit is not newly provided as in the coin processing apparatus described in Japanese Patent Application Laid-open No. 2010-33410, because a coin collection unit is not present, if a coin storage of a certain denomination becomes full, input of coins of that denomination cannot be performed, thereby causing a state in which commodity trading cannot be performed.

On the other hand, a certain number of coin storages, for example, six coin storages are provided in the coin processing apparatus and used as a coin storage for each denomination. However, all the coin storages are not always used according to the place, area, or country where the coin processing apparatus is provided. If there is an unused coin storage, effective use of the unused coin storage has been pointed out.

### SUMMARY OF THE INVENTION

It is an object of the present disclosure to at least partially solve the problems in the conventional technology.

In some embodiments, a coin processing apparatus includes: a predetermined number of coin storages; and a money input/output control unit configured to set, when a number of the coin storages used as denomination-fixed coin storages is less than the predetermined number, at least one remaining coin storage as a temporary coin storage, and to execute money input/output control of coins by using the denomination-fixed coin storages and the at least one temporary coin storage.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration of a money processing apparatus including a coin processing apparatus according to an embodiment of the present disclosure;

FIG. 2 is a block diagram illustrating a configuration of a control system of the money processing apparatus;

FIG. 3 is a plan view schematically illustrating an internal configuration of the coin processing apparatus illustrated in FIG. 1;

FIG. 4 is a plan view schematically illustrating an internal configuration of a coin processing apparatus in which an unused coin storage, of coin storages, is set as a temporary storage;

FIG. 5 is a flowchart illustrating a money input/storage control process procedure by a money input/output control unit;

FIG. 6 is a flowchart illustrating a near-empty storage control process procedure by the money input/output control unit;

FIG. 7 is a flowchart illustrating a near-full storage control process procedure by the money input/output control unit;

FIG. 8 is a diagram illustrating an example of setting of a temporary storage in a case where the number of unused coin storages, of the coin storages, is more than a half of all the coin storages;

FIG. 9 is a diagram illustrating a simplified configuration example in a case where the temporary storage is set as a temporary collection box; and

FIG. 10 is a diagram illustrating an example in a case where the temporary storage is set as a temporary collection box.

### DETAILED DESCRIPTION OF THE PREFERRED EMBODIMENTS

Embodiments for carrying out the present disclosure will be described below with reference to the accompanying drawings.

Configuration of Money Processing Apparatus

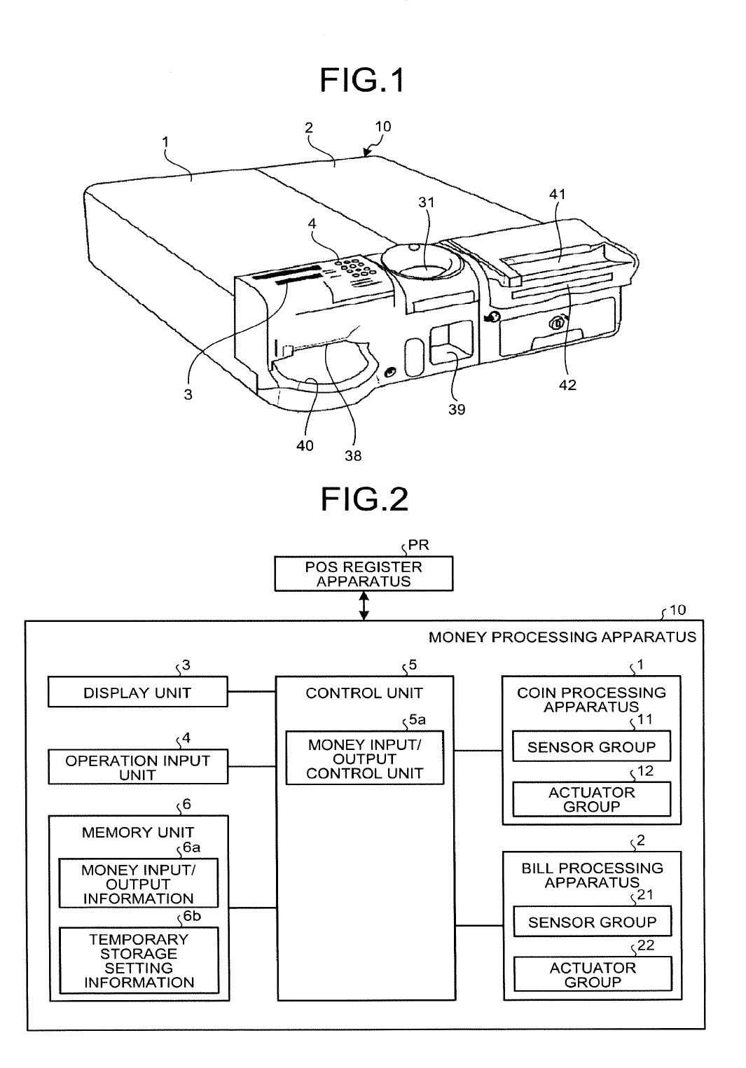

FIG. 1 is a perspective view illustrating a configuration of a money processing apparatus 10 including a coin processing apparatus 1 according to an embodiment of the present disclosure. FIG. 2 is a block diagram illustrating a configuration of a control system of the money processing apparatus 10. The money processing apparatus 10 illustrated herein is used as an automatic change machine connected to a POS register apparatus PR in shops such as supermarkets and convenience stores. As illustrated in FIG. 1 and FIG. 2, a flat surface is formed on an upper surface of the money processing apparatus 10, and the POS register apparatus PR being a higher-level device is placed on the flat surface. The money processing apparatus 10 includes the coin processing apparatus 1 that performs input and output of coins and a bill processing apparatus 2 that performs input and output of bills. The coin processing apparatus 1 and the bill processing apparatus 2 are covered by an apparatus body formed in a rectangular shape and arranged adjacent to each other.

The coin processing apparatus 1 includes a coin slot 31 on the right side of a front end upper surface of the apparatus body. A coin output port 38 is formed on the left side on a front surface of the apparatus body of the coin processing apparatus 1, and coins discharged from the coin output port 38 are received in a receiving tray 40. A coin return port 39 is provided on the right side on the front surface of the apparatus body. Meanwhile, a bill slot 41 and a bill output port 42 are provided on an upper part of the front surface of the apparatus body of the bill processing apparatus 2.

The coin processing apparatus 1 includes a display unit 3 and an operation input unit 4 on the left side on the front end upper surface. The display unit 3 and the operation input unit 4 are also a display unit and an operation input unit of the bill processing apparatus 2. A control unit 5 and a memory unit 6 are provided in the money processing apparatus 10.

The coin processing apparatus 1 includes a sensor group 11 including various types of elements and an actuator group 12 including various types of elements. The bill processing unit 2 also includes various types of sensor group 21 and actuator group 22.

The control unit 5 includes a money input/output control unit 5a. The money input/output control unit 5a performs money input processing in response to a money-input permitting instruction, upon insertion of money after the money-input permitting instruction is provided from the POS register apparatus PR, and performs money output processing in response to a money output instruction when the money output instruction is provided from the POS register apparatus PR. The money input/output control unit 5a also performs processing to sequentially store contents of the performed money input processing and money output processing in the memory unit 6 as money input/output information 6a, while performing the money input processing and the money output processing.

Further, among a predetermined number of coin storages in the coin processing apparatus 1, when performing coin input/output processing for each denomination by using coin storages of less than a predetermined number, as denomination-fixed coin storages, the money input/output control unit 5a sets the remaining number of coin storages as temporary coin storages, and performs the coin input/output processing by using the denomination-fixed coin storages and the temporary coin storages. Information of the set temporary coin storages is memorized in the memory unit 6 as temporary storage setting information 6b.

Internal Configuration of Coin Processing Apparatus

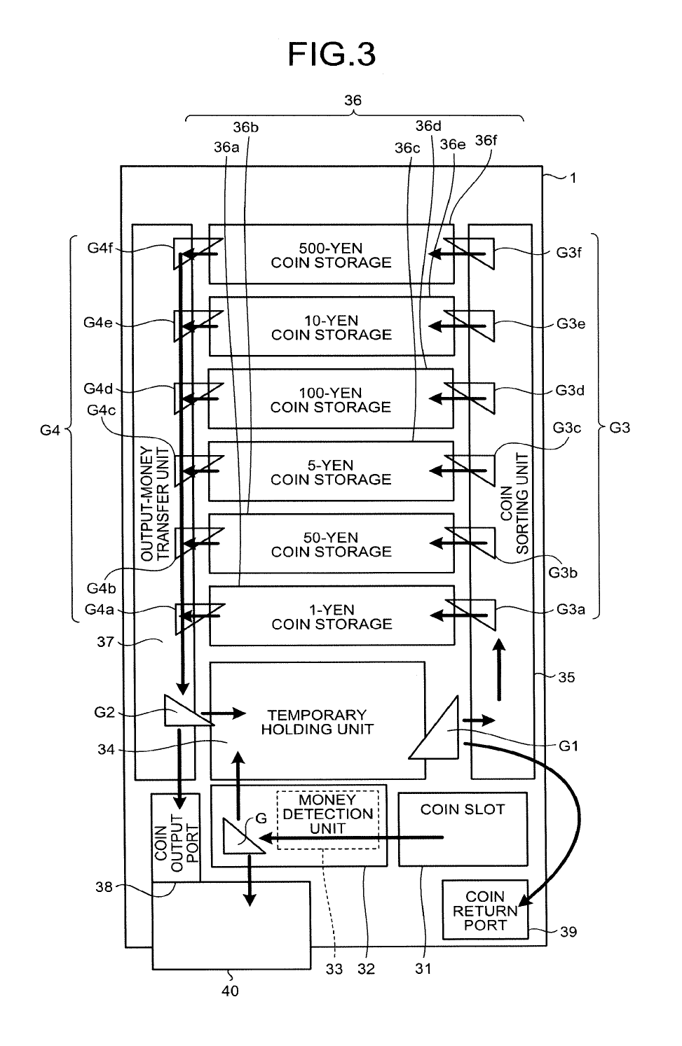

FIG. 3 is a plan view schematically illustrating an internal configuration of the coin processing apparatus 1 illustrated in FIG. 1. In FIG. 3, the coin slot 31 is an opening for accepting therethrough coins inserted into the apparatus body. The coins inserted to the coin slot 31 are detected by an insertion detection sensor (not illustrated) and transferred by an input-money transfer unit 32 in response to the money input permitting instruction from the POS register apparatus PR. A money detection unit 33 provided in the input-money transfer unit 32 determines the authenticity and denomination of coins. If the transferred coin is a specie, the coin is held in a temporary holding unit 34. On the other hand, if the transferred coin is not a specie, the coin is returned to the receiving tray 40 via a switching gate G and the coin output port 38. When there is a return instruction from the POS register apparatus PR or from a return lever (not illustrated), the coin held in the temporary holding unit 34 is returned to the coin return port 39 via a switching gate G1.

Thereafter, the temporary holding unit 34 functions as a transfer path, and coins held in the temporary holding unit 34 are output to a coin sorting unit 35 being a transfer path via the switching gate G1 and transferred. Coins transferred by the coin sorting unit 35 are stored in the coin storages 36 according to the denomination. Inside the apparatus body, there are six coin storages 36 of a 1-yen coin storage 36a, a 50-yen coin storage 36b, a 5-yen coin storage 36c, a 100-yen coin storage 36d, a 10-yen coin storage 36e, and a 500-yen coin storage 36f. The respective coin storages 36 store therein inserted coins individually for each of denominations. The coin sorting unit 35 includes switching gates G3 (G3a to G3f) that sorts coins into the respective coin storages 36 according to the denomination.

Coins stored in the respective coin storages 36 can be transferred to the temporary holding unit 34 via switching gates G4 (G4a to G4f), an output-money transfer unit 37, and a switching gate G2. The temporary holding unit 34 also functions as a checking box for performing a checking operation in which the coins stored in the respective coin storages 36 are emptied once and the number of stored coins in the respective coin storages 36 is recalculated for checking.

Thereafter, the coins of denominations corresponding to a money output instruction from the POS register apparatus PR are collectively taken out from the respective coin storages 36 via the switching gates G4, the output-money transfer unit 37, and the switching gate G2 and discharged to the outside of the apparatus body from the coin output port 38. When coins stored in the respective coin storages 36 are to be collected collectively, the coins are also discharged from the coin output port 38. In the case of collective collection, coins may be discharged from a collection output port provided separately.

Setting of Temporary Storage

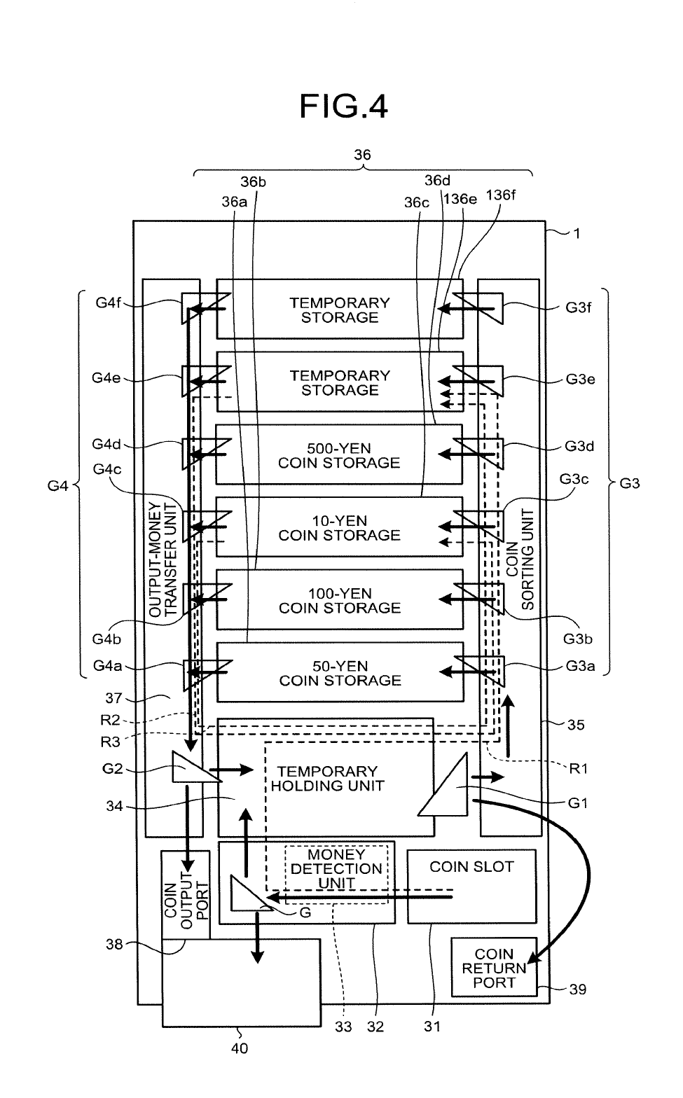

In FIG. 3, all the coin storages 36 are used. However, if input and output of 1-yen and 5-yen coins are not to be performed, as illustrated in FIG. 4, coin storage mechanisms for the 1-yen coin storage 36a and the 5-yen coin storage 36c are not set. Other four coin storages of the 50-yen coin storage 36a, the 100-yen coin storage 36b, the 10-yen coin storage 36c, and the 500-yen coin storage 36d are set as the denomination-fixed coin storages, to which each denomination is fixed, and the remaining coin storages 36e (136e) and 36f (136f) are set as temporary coin storages (temporary storages 136e and 136f). The temporary storages 136e and 136f function as a temporary storage of any denomination of the 50-yen coin storage 36a, the 100-yen coin storage 36b, the 10-yen coin storage 36c, and the 500-yen coin storage 36d.

For example, if the 10-yen coin storage 36c is full and 10-yen coins are inserted, the temporary storage 136e is set as the temporary storage for the 10-yen coin storage 36c, and the inserted 10-yen coins are stored in the temporary storage 136e (see a route R1). Accordingly, even if the 10-yen coin storage 36c is full, commodity trading is continued. Further, if 10-yen coins stored in the 10-yen coin storage 36c are short (when being less than a lower limit number of coins), 10-yen coins stored in the temporary storage 136e can be restocked in the 10-yen coin storage 36c (see a route R2). Alternatively, when 10-yen coins stored in the 10-yen coin storage 36c is nearly full (when exceeding an upper limit number of coins), 10-yen coins can be moved and stored from the 10-yen coin storage 36c to the temporary storage 136e (see a route R3). In these cases, the 10-yen coin storage 36c has a double storage capacity including the temporary storage 136e.

Money Input/Storage Control Process

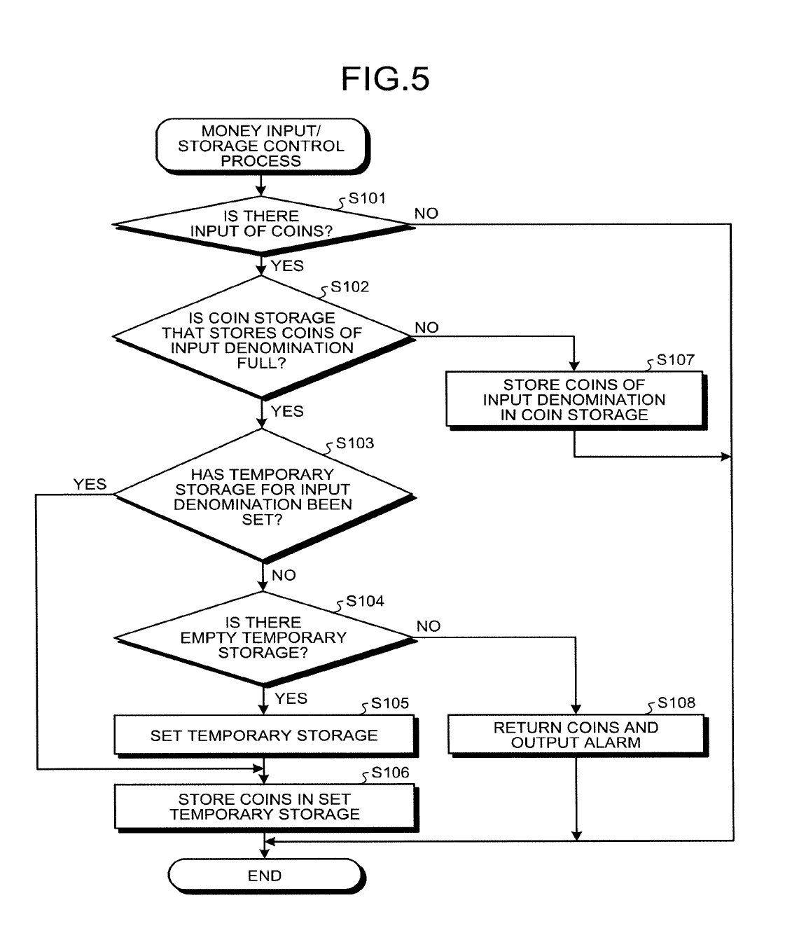

FIG. 5 is a flowchart illustrating a money input/storage control process procedure by the money input/output control unit 5a. The money input/storage control process is a process to continue commodity trading even if coins of a certain denomination are fully stored. As illustrated in FIG. 5, the money input/output control unit 5a determines whether coins are input (Step S101). If coins are not input (NO at Step S101), the money input/output control unit 5a finishes the process as it is. On the other hand, if coins are input (YES at Step S101), the money input/output control unit 5a determines whether the coin storage 36 for storing the input coins of the denomination is full (Step S102). If the coin storage 36 for storing the input coins of the denomination is not full (NO at Step S102), the money input/output control unit 5a stores coins in the coin storage 36 for storing the input coins of the denomination (Step S107), to finish the process. In this case, the coin storage 36 can store therein coins until it becomes full.

If the coin storage 36 for storing the input coins of the denomination is full (YES at Step S102), the money input/output control unit 5a further determines whether a temporary storage for the denomination of the input coins has been set (Step S103). If a temporary storage for the denomination of the input coins has been set (YES at Step S103), the money input/output control unit 5a stores coins in the set temporary storage (Step S106), to finish the process.

If a temporary storage for the denomination of the input coins has not been set (NO at Step S103), the money input/output control unit 5a further determines whether there is an empty (unused) temporary storage (Step S104). If there is no empty temporary storage (NO at Step S104), the money input/output control unit 5a returns the coins and outputs an alarm indicating that the coin storage is full (Step S108), to finish the process.

If there is an empty temporary storage (YES at Step S104), the money input/output control unit 5a sets a temporary storage for the denomination, for which the storage has become full (Step S105), and stores coins of the denomination, for which the storage has become full, in the set temporary storage (Step S106), to finish the process.

Near-Empty Storage Control Process

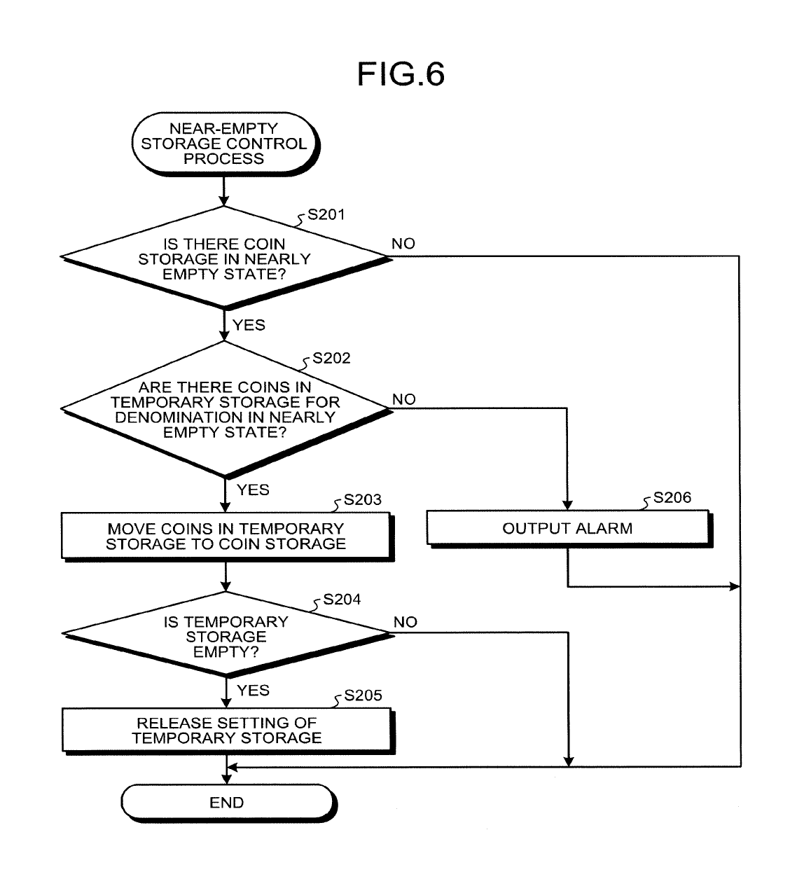

FIG. 6 is a flowchart illustrating a near-empty storage control process procedure by the money input/output control unit 5a. The near-empty storage control process is a process to restock coins beforehand, when coins of a certain denomination is in a state being less than the lower limit number of coins (near empty).

As illustrated in FIG. 6, the money input/output control unit 5a first determines whether there is a coin storage 36 in a nearly empty state (Step S201). If there is no coin storage 36 in a nearly empty state (NO at Step S201), the money input/output control unit 5a finishes the process as it is. On the other hand, if there is a coin storage 36 in a nearly empty state (YES at Step S201), the money input/output control unit 5a further determines whether there are coins in a temporary storage for the denomination in the nearly empty state (Step S202). If there are no coins in the temporary storage for the denomination in the nearly empty state (NO at Step S202), the money input/output control unit 5a outputs an alarm indicating the nearly empty state (Step S206), to finish the process.

On the other hand, if there are coins in the temporary storage for the denomination in the nearly empty state (YES at Step S202), the money input/output control unit 5a moves the coins in the temporary storage to the coin storage in the nearly empty state (Step S203). The money input/output control unit 5a further determines whether the temporary storage becomes empty by this coin movement (Step S204). If the temporary storage is not empty (NO at Step S204), the money input/output control unit 5a finishes the process as it is. On the other hand, if the temporary storage becomes empty (YES at Step S204), the money input/output control unit 5a releases the setting of the temporary storage (Step S205), to finish the process.

Near-Full Storage Control Process

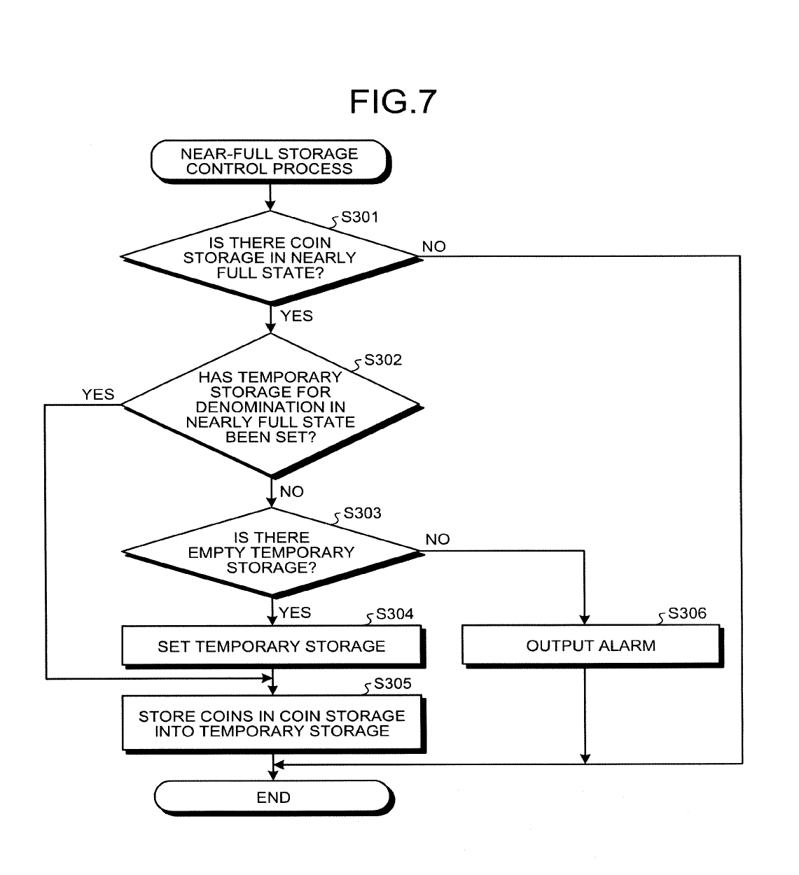

FIG. 7 is a flowchart illustrating a near-full storage control process procedure by the money input/output control unit 5a. The near-full storage control process is a process to collect coins beforehand to enable input of coins, when coins of a certain denomination is in a state exceeding the upper limit number of coins (near full).

As illustrated in FIG. 7, the money input/output control unit 5a determines whether there is a coin storage 36 in a nearly full state (Step S301). If there is no coin storage 36 in a nearly full state (NO at Step S301), the money input/output control unit 5a finishes the process as it is. On the other hand, if there is a coin storage 36 in a nearly full state (YES at Step S301), the money input/output control unit 5a further determines whether a temporary storage for coins of the denomination in the nearly full state has been set (Step S302). If a temporary storage for coins of the denomination in the nearly full state has been set (YES at Step S302), the money input/output control unit 5a stores coins of the denomination in the nearly full state in the set temporary storage (Step S305), to finish the process.

On the other hand, if a temporary storage for coins of the denomination in the nearly full state has not been set (NO at Step S302), the money input/output control unit 5a further determines whether there is an empty temporary storage (Step S303). If there is no empty temporary storage (NO at Step S303), the money input/output control unit 5a outputs an alarm indicating the nearly full state (Step S306), to finish the process. On the other hand, if there is an empty temporary storage (YES at Step S303), the money input/output control unit 5a sets the empty temporary storage for the coins of the denomination in the nearly full state (Step S304) and stores the coins of the denomination in the nearly full state in the set temporary storage (Step S305), to finish the process.

When Number of Denomination-Fixed Coin Storages is Equal to or Less than Half

When a preset number of denomination-fixed coin storages being used is equal to or less than half the number of all the coin storages, the money input/output control unit 5a performs setting to allocate a temporary storage respectively to all the denominations at least stored in the denomination-fixed coin storages.

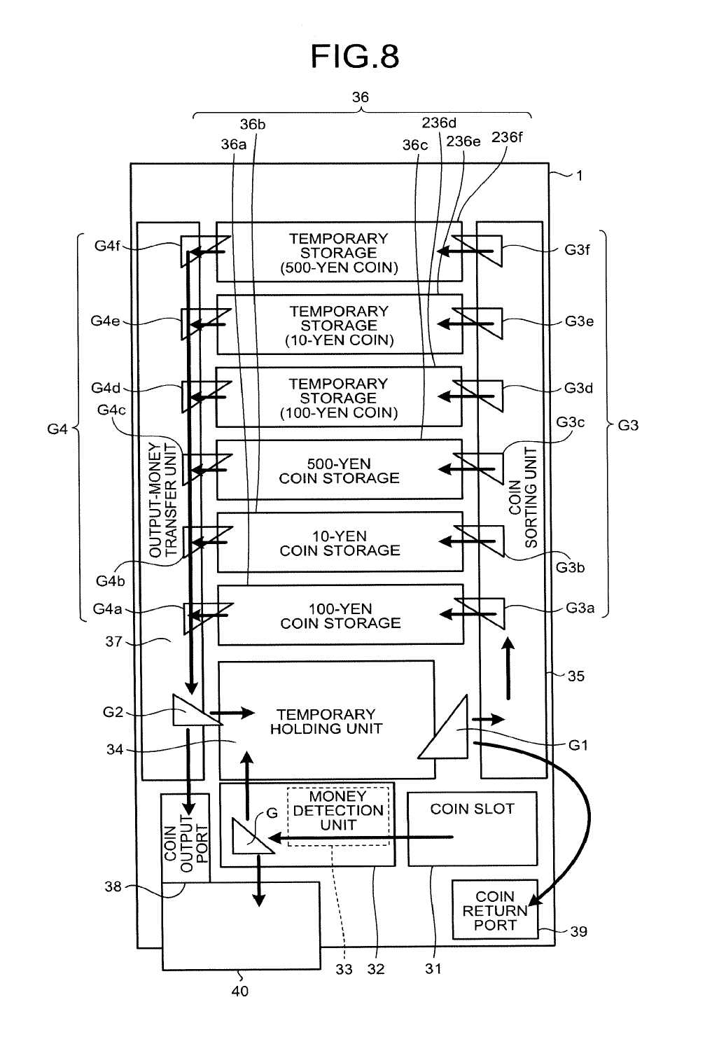

For example, as illustrated in FIG. 8, the money input/output control unit 5a sets the 100-yen coin storage 36a, the 10-yen coin storage 36b, and the 500-yen coin storage 36c of the six coin storages 36 as the denomination-fixed coin storages. The money input/output control unit 5a then sets remaining three coin storages 236d, 236e, and 236f respectively as the temporary storages of the 100-yen coins, 10-yen coins, and 500-yen coins.

By the setting of the temporary storages, the storage capacity of all the denominations becomes double the storage capacity of the respective denomination-fixed coin storages (the 100-yen coin storage 36a, the 10-yen coin storage 36b, and the 500-yen coin storage 36c).

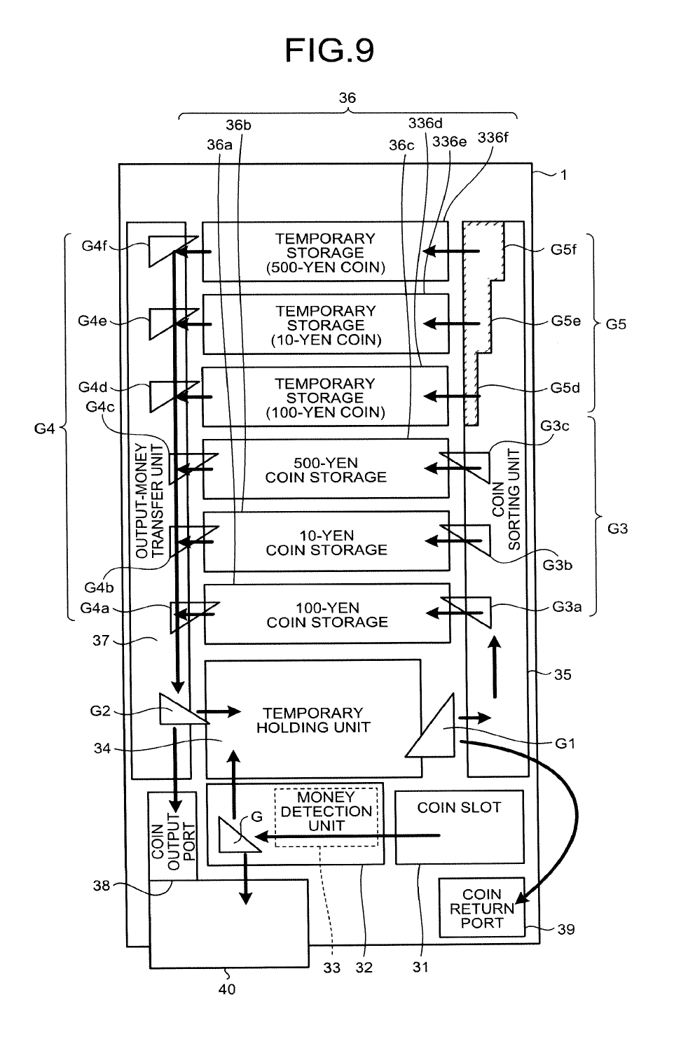

As illustrated in FIG. 9, if the temporary storage is allocated to all the denominations and it is known beforehand that these temporary storages are caused to function as temporary collection boxes 336d, 336e, and 336f that perform only collection in the coin processing apparatus 1, an external sorting mechanisms G5 (G5d, G5e, G5f) can be provided instead of the switching gates G3d, G3e, and G3f. Because the external sorting mechanisms G5 do not use an actuator such as a solenoid, a simple configuration can be adopted.

Setting of Temporary Collection Box

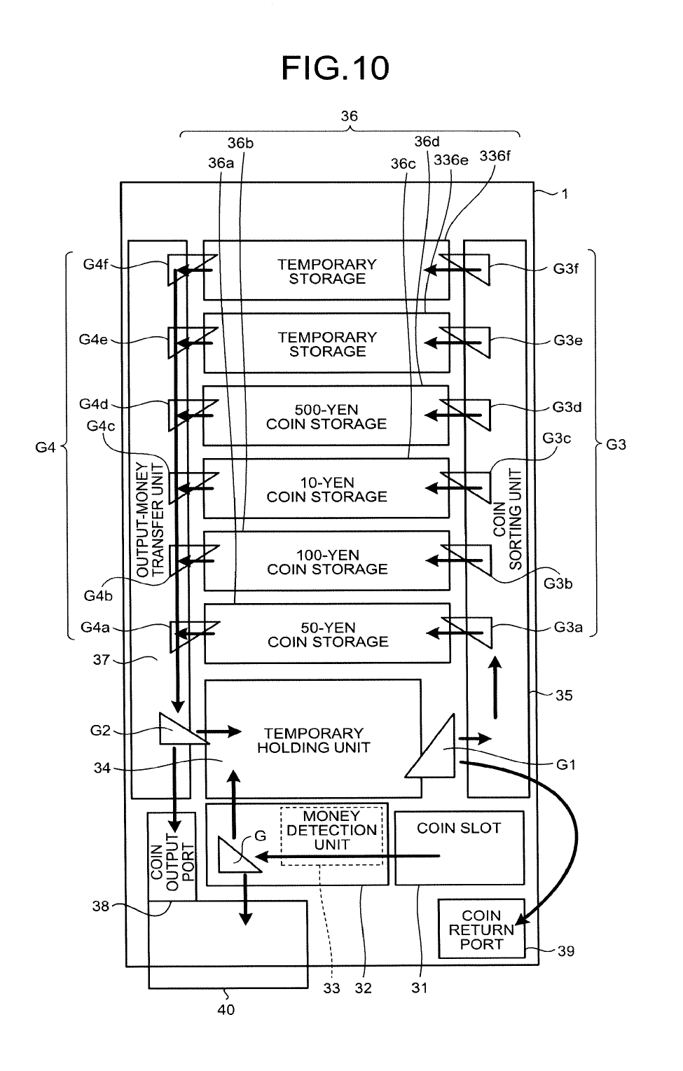

Further, as illustrated in FIG. 10, temporary storages 136e and 136f can be caused to function as the temporary collection boxes 336e and 336f that perform only collection in the coin processing apparatus 1. In this case, because the temporary collection boxes 336e and 336f do not perform output of coins other than collective collection to the outside of the coin processing apparatus 1, coins of different denominations can be mixed and collected internally until these collection boxes become full. In other words, the temporary collection box functions as a mixed box. The function of the mixed box is similar to that of the temporary collection box illustrated in FIG. 9.

According to the present disclosure, when coin storages in the number less than a predetermined number, among the predetermined number of coin storages, are used as the denomination-fixed coin storages to perform coin input/output processing for each denomination, the remaining number of coin storages are set as the temporary coin storages, and input/output control of coins is executed by using the denomination-fixed coin storages and the temporary coin storages. Accordingly, the storage capacity of the denomination-fixed coin storages increases to increase the continuity of commodity trading.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A coin processing apparatus comprising:
a predetermined number of coin storages; and
a money input/output control unit configured to set, when a number of the coin storages used as denomination-fixed coin storages is less than the predetermined number, at least one remaining coin storage as a temporary coin storage, and to execute money input/output control of coins by using the denomination-fixed coin storages and the at least one temporary coin storage.

2. The coin processing apparatus according to claim 1, wherein when there are coins to be input to the denomination-fixed coin storage and coins stored in the denomination-fixed coin storage are full, the money input/output control unit sets one of the temporary coin storages as a temporary coin storage with respect to the denomination of coins to be input, and stores the coins in the set temporary coin storage.

3. The coin processing apparatus according to claim 1, wherein when an upper limit number of coins is exceeded in the denomination-fixed coin storage, the money input/output control unit sets one of the temporary coin storages as a temporary coin storage that stores coins of the denomination having exceeded the upper limit number of coins, and stores coins in the set temporary coin storage.

4. The coin processing apparatus according to claim 2, wherein when the denomination-fixed coin storage stores coins less than a lower limit number of coins, the money input/output control unit restocks coins from the temporary coin storage that stores coins of the denomination in the number less than the lower limit number of coins.

5. The coin processing apparatus according to claim 3, wherein when the denomination-fixed coin storage stores coins less than a lower limit number of coins, the money input/output control unit restocks coins from the temporary coin storage that stores coins of the denomination in the number less than the lower limit number of coins.

6. The coin processing apparatus according to claim 1, wherein when the number of the denomination-fixed coin storages is equal to or half the predetermined number, the money input/output control unit allocates and sets the temporary coin storage for each denomination at least stored in the denomination-fixed coin storages.

7. The coin processing apparatus according to claim 1, wherein the money input/output control unit sets a part or all the temporary coin storages as a temporary collection box that stores therein coins of different denominations in a mixed state.
